(19) United States
(12) Patent Application Publication
(10) Pub. No.: US 2026/0103027 A1
(43) Pub. Date: Apr. 16, 2026

(54) NON-PNEUMATIC TIRE

(71) Applicant: BRIDGESTONE CORPORATION, Chuo-ku, Tokyo (JP)

(72) Inventor: Akihiko ABE, Chuo-ku, Tokyo (JP)

(73) Assignee: BRIDGESTONE CORPORATION, Chuo-ku, Tokyo (JP)

(21) Appl. No.: 19/116,365

(22) PCT Filed: Aug. 29, 2023
(86) PCT No.: PCT/JP2023/031316

§ 371 Date: Mar. 28, 2025

(30) Foreign Application Priority Data
Oct. 24, 2022 (JP) 2022-170074

(51) Int. Cl. B60C 7/14

(52) U.S. Cl. CPC B60C 7/146

(57) ABSTRACT

Provided is a non-pneumatic tire comprising: an inner cylinder 1, an outer cylinder disposed on a tire outer circumferential side of the inner cylinder 3, and a connecting body 4, wherein the connecting body has: a plurality of unit-connecting-body portions 41 and a plurality of bridges 42, each of the unit-connecting-body portions has: an inner annular part 411, a middle annular part 412, an outer connecting body part 413, each of the bridges connects tire circumferential end portions 411t of the inner annular parts adjacent to each other in the tire circumferential direction, and tire circumferential end portions 412t of the middle annular parts adjacent to each other in the tire circumferential direction are connected to each other.

### TECHNICAL FIELD

The present disclosure relates to a non-pneumatic tire.

This application claims priority based on Japanese Patent Application No. 2022-170074, filed in Japan on Oct. 24, 2022, and the entire contents of which are incorporated herein by reference.

### BACKGROUND

There have been non-pneumatic tires for some time (see, for example, Patent Document 1).

### CITATION LIST

### Patent Literature

PTL 1: JP 2020-083243 A

### SUMMARY

### Technical Problem

However, there was room for improvement in ride comfort performance with conventional non-pneumatic tires.

The object of the resent disclosure is to provide a non-pneumatic tire that can improve the ride comfort performance.

### Solution to Problem

[1] A non-pneumatic tire comprising:
an inner cylinder,
an outer cylinder disposed on a tire outer circumferential side of the inner cylinder, and
a connecting body that connects the inner cylinder and the outer cylinder, wherein
the connecting body has:
   a plurality of unit-connecting-body portions arranged along a tire circumferential direction, and
   a plurality of bridges that connect the plurality of unit-connecting-body portions to each other, each of the unit-connecting-body portions has:
   an inner annular part having a pair of inner branches that are connected to each other on the inner cylinder and gradually move away from each other in the tire circumferential direction as moving outward in a tire radial direction, then gradually approach each other and are connected to each other,
   a middle annular part having a pair of middle branches that are connected to each other at an end portion on the tire outer circumferential side of the inner annular part and gradually move away from each other in the tire circumferential direction as moving outward in the tire radial direction, then gradually approach each other and are connected to each other, and
   an outer connecting body part having a pair of outer branches that are connected to each other at an end portion on the tire outer circumferential side of the middle annular part and gradually move away from each other in the tire circumferential direction as moving outward in the tire radial direction, and then are connected to the outer cylinder,
each of the bridges connects tire circumferential end portions of the inner annular parts adjacent to each other in the tire circumferential direction,
tire circumferential end portions of the middle annular parts adjacent to each other in the tire circumferential direction are connected to each other,
each of the inner annular parts has a length in the tire radial direction longer than a length in the tire circumferential direction, and
each of the middle annular parts has a length in the tire circumferential direction longer than a length in the tire radial direction.

### Advantageous Effect

According to the present disclosure, it is possible to provide a non-pneumatic tire that can improve the ride comfort performance.

### BRIEF DESCRIPTION OF THE DRAWINGS

In the accompanying drawings:

FIG. 1 is a side view of a non-pneumatic tire in accordance with one embodiment of the present disclosure, viewed from one side in the tire width direction;

FIG. 2 is an enlarged view illustrating a part of the non-pneumatic tire in FIG. 1;

FIG. 3 is an illustration to explain the behavior of the non-pneumatic tire in FIG. 2 when a load is applied to the tire; and

FIG. 4 is an enlarged view illustrating a part of a non-pneumatic tire in accordance with Comparative Example 1.

### DETAILED DESCRIPTION

The non-pneumatic tire in accordance with this disclosure can be used on any moving object (e.g., small mobilities, light vehicles, passenger vehicles, various other vehicles, motorcycles, wheelchairs, etc.), and is particularly suitable for use on the small mobilities or the light vehicles.

Embodiments of a non-pneumatic tire in accordance with the present disclosure will now be described with reference to the drawings.

The same components and parts are designated by the same reference numerals/symbols in each drawing.

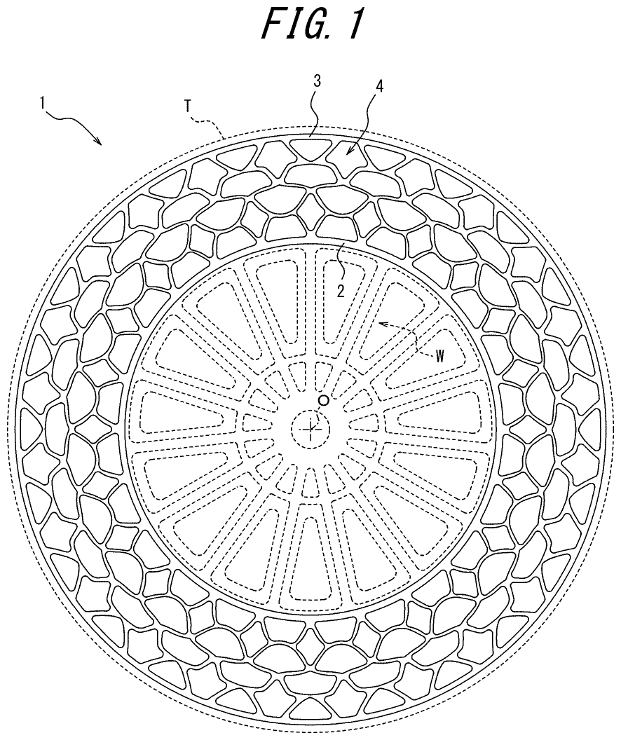

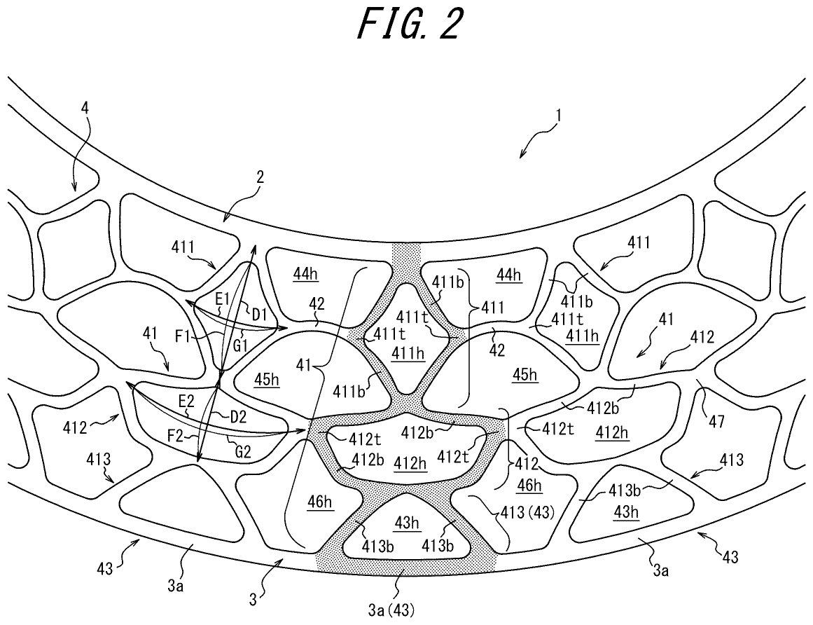

FIG. 1 is a side view of a non-pneumatic tire 1 in accordance with one embodiment of the present disclosure, viewed from one side in the tire width direction. FIG. 2 is an enlarged view illustrating a part of the non-pneumatic tire 1 in FIG. 1.

As illustrated in FIG. 1, the non-pneumatic tire 1 is configured to be provided on the outer circumferential side of a wheel W, which is connected to an axle (not illustrated in the figure). The non-pneumatic tire 1 may be configured as a single unit with the wheel W, or it may be configured separately from the wheel W. The non-pneumatic tire 1 and the wheel W are arranged on the same axis as the central axis O of the axle (not illustrated in the figure). In other words, the central axis O of the axle (not illustrated in the figure) coincides with the tire central axis O of the non-pneumatic tire 1.

In this document, the direction parallel to the tire central axis O is referred to as the “tire width direction”, the direction perpendicular to the tire central axis O is referred to as the “axially perpendicular direction”, the radial direction and the circumferential direction centered on the tire central axis O are referred to as the “tire radial direction” and the “tire circumferential direction”, respectively. The side of the tire that is closer to the tire central axis O is referred to as the “tire radially inner side” or “tire inner circumferential side”, and the side that is further from the tire central axis O is referred to as the “tire radially outer side” or “tire outer circumferential side”.

In this document, when explaining the configuration (shape, dimensions, etc.) of the non-pneumatic tire 1, unless otherwise specified, it shall be assumed that the non-pneumatic tire 1 is not in contact with the ground and that no load is applied to the non-pneumatic tire 1.

As illustrated in FIGS. 1 and 2, the non-pneumatic tire 1 comprises an inner cylinder 2, an outer cylinder 3, and a connecting body 4. It is preferable, as illustrated in FIG. 1, that the non-pneumatic tire 1 further comprises a tread member T made of rubber or the like on the tire outer circumferential side of the outer cylinder 3. In FIG. 2, the tread member Tis omitted.

In addition, in FIG. 2, to make it easier to understand the configuration described in this document, a part of the non-pneumatic tire 1 is shaded with dot hatching.

The connecting body 4 and the outer cylinder 3 are configured to be elastically deformable. The inner cylinder 2 may also be configured to allow elastic deformation.

The inner cylinder 2, the connecting body 4, and the outer cylinder 3 may be made from the same material as a single piece (i.e. as a single part) by injection molding or other means.

The material constituting each of the connecting body 4 and the outer cylinder 3 is preferably an elastic body, and is preferably a resin such as a thermoplastic elastomer.

The inner cylinder 2 is preferably made of the same material as the material that constitutes the connecting body 4 and the outer cylinder 3.

It is preferable that the cross-sectional shape in the axially perpendicular direction of the connecting body 4 is substantially the same throughout the entire length in the tire width direction of the connecting body 4.

It is preferable that the inner cylinder 2, the connecting body 4, and the outer cylinder 3 each have substantially the same length in the tire width direction. It is preferable that the length of the inner cylinder 2, the connecting body 4, and the outer cylinder 3 in the tire width direction is substantially the same as the length of the non-pneumatic tire 1 in the tire width direction.

The inner cylinder 2 is either integrally connected to the wheel W, or is configured separately from the wheel W and to be attached to the wheel W.

The outer cylinder 3 is disposed on the tire outer circumferential side of the inner cylinder 2.

The connecting body 4 is located between the inner cylinder 2 and the outer cylinder 3, and connects the inner cylinder 2 and the outer cylinder 3.

As illustrated in FIG. 2, the connecting body 4 has a plurality of unit-connecting-body portions 41 arranged along the tire circumferential direction, and a plurality of bridges 42 that connect the plurality of unit-connecting-body portions 41 to each other.

As illustrated in FIG. 2, each unit-connecting-body portion 41 has an inner annular part 411, a middle annular part 412, and an outer connecting body part 413.

The inner annular part 411 has a pair of inner branches 411b that face each other in the tire circumferential direction. This pair of inner branches 411b are connected to each other on the inner cylinder 2 and gradually move away from each other in the tire circumferential direction as moving outward in the tire radial direction, then gradually approach each other and are connected to each other. In this way, the inner annular part 411 is configured in a circular shape. The inner annular part 411 defines an inner hole 411h on its inner circumference. The inner hole 411h penetrates the connecting body 4 in the tire width direction. The inner branches 411b that make up each side are not in straight lines, but are formed by combining small sides that are curved gently, as in the example illustrated in the figure.

The middle annular part 412 has a pair of middle branches 412b that face each other in the tire circumferential direction. This pair of middle branches 412b are connected to each other at the end portion on the tire outer circumferential side of the inner annular part 411 and gradually move away from each other in the tire circumferential direction as moving outward in the tire radial direction, then gradually approach each other and are connected to each other. In this way, the middle annular part 412 is configured in a circular shape. The middle annular part 412 defines a middle hole 412h on its inner circumference. The middle hole 412h penetrates the connecting body 4 in the tire width direction. The middle branches 412b that make up each side are not in straight lines, but are formed by combining small sides that are curved gently, as in the example illustrated in the figure.

The outer connecting body part 413 has a pair of outer branches 413b that face each other in the tire circumferential direction. This pair of outer branches 413b are connected to each other at the end portion on the tire outer circumferential side of the middle annular part 412 and gradually move away from each other in the tire circumferential direction as moving outward in the tire radial direction, and then are connected to the outer cylinder 3. The end portions on the tire outer circumferential side of the pair of outer branches 413b of the outer connecting body part 413 are spaced apart from each other in the tire circumferential direction. The outer branches 413b that make up each side are not in straight lines, but are curved gently in the example illustrated in the figure.

An outer annular part 43 is composed of the outer connecting body part 413, and an outer cylinder connecting part 3a that is a part of the outer cylinder, connecting the end portions on the tire outer circumference side of the pair of outer branches 413b of the outer connecting body part 413. The outer annular part 43 is configured in a circular shape. The outer annular part 43 defines an outer hole 43h on its inner circumference. The outer hole 43h penetrates the connecting body 4 in the tire width direction. The outer annular part 43 is substantially triangular in shape with its base on the tire outer circumferential side.

The inner annular parts 411 that are adjacent to each other in the tire circumferential direction are spaced apart from each other in the tire circumferential direction. The inner annular part 411 has a pair of tire circumferential end portions 411t on both sides in the tire circumferential direction. The pair of tire circumferential end portions 411t of the inner annular part 411 each correspond to the portion, of the pair of inner branches 411b of the inner annular part 411, that change its extending direction toward each other after separating from each other in the tire circumferential direction as they move outward in the tire radial direction, in other words, of the pair of inner branches 411b of the inner annular part 411, the apex portions of the pair of inner branches 411b of the inner annular part 411 that project toward one side and the other side in the tire circumferential direction, respectively. The pair of tire circumferential end portions 411t of the inner annular part 411 may be smoothly curved, as in the example illustrated in FIG. 2, or angular by folding.

Each bridge 42 connects the tire circumferential end portions 411t of the inner annular parts 411 adjacent to each other in the tire circumferential direction.

In the example illustrated in FIG. 2, each bridge 42 extends along the tire circumferential direction (i.e., substantially parallel to the tire circumferential direction) and also extends in a curved line that is curved convexly toward the tire inner circumferential side.

However, the shape of each bridge 42 may be arbitrary.

The middle annular part 412 has a pair of tire circumferential end portions 412t on both sides in the tire circumferential direction. The pair of tire circumferential end portions 412t of the middle annular part 412 each correspond to the portion, of the pair of middle branches 412b of the middle annular part 412, that change the extending direction toward each other after separating from each other in the tire circumferential direction as they move outward in the tire radial direction, in other words, of the pair of middle branches 412b of the middle annular part 412, the apex portions of the pair of middle branches 412b of the middle annular part 412 that project toward one side and the other side in the tire circumferential direction, respectively. The pair of tire circumferential end portions 412t of the middle annular part 412 may be smoothly curved, as in the example illustrated in FIG. 2, or angular by folding.

The tire circumferential end portions 412t of the middle annular parts 412 adjacent to each other in the tire circumferential direction are connected to each other.

As in the example illustrated in FIG. 2, it is preferable if the outer connecting body parts 413 adjacent to each other in the tire circumferential direction are spaced apart from each other in the tire circumferential direction.

As illustrated in FIG. 2, each of the inner annular parts 411 has a length D1 in the tire radial direction longer than the length E1 in the tire circumferential direction, i.e., it has a longitudinal shape in the side view of the non-pneumatic tire 1 as illustrated in FIG. 2.

Here, the length D1 in the tire radial direction of the inner annular part 411 refers to the largest length in the tire radial direction of the outer edge shape of the inner annular part 411 among the length in the tire radial direction at each position in the tire circumferential direction (in the example illustrated in FIG. 2, it corresponds to the length of the arrow D1).

In addition, the length E1 in the tire circumferential direction of the inner annular part 411 refers to the largest length in the tire circumferential direction of the outer edge shape of the inner annular part 411 among the length in the tire circumferential direction at each position in the tire radial direction (in the example illustrated in FIG. 2, it corresponds to the length of the arrow E1).

Similarly, as illustrated in FIG. 2, the inner hole 411h that is defined by each of the inner annular part 411 has a length F1 in the tire radial direction longer than the length G1 in the tire circumferential direction, i.e., it has a longitudinal shape in the side view of the non-pneumatic tire 1.

Here, the length F1 in the tire radial direction of the inner hole 411h refers to the largest length in the tire radial direction of the inner hole 411h among the length in the tire radial direction at each position in the tire circumferential direction.

In addition, the length G1 in the tire circumferential direction of the inner hole 411h refers to the largest length in the tire circumferential direction of the inner hole 411h among the length in the tire circumferential direction at each position in the tire radial direction.

As illustrated in FIG. 2, each middle annular part 412 has a length E2 in the tire circumferential direction longer than the length D2 in the tire radial direction, i.e., it has a transverse shape in the side view of the non-pneumatic tire 1.

Here, the length E2 in the tire circumferential direction of the middle annular part 412 refers to the largest length in the tire circumferential direction of the outer edge shape of the middle annular part 412 among the length in the tire circumferential direction at each position in the tire radial direction (in the example illustrated in FIG. 2, it corresponds to the length of the arrow E2).

In addition, the length D2 in the tire radial direction of the middle annular part 412 refers to the largest length in the tire radial direction of the outer edge shape of the middle annular part 412 among the length in the tire radial direction at each position in the tire circumferential direction (in the example illustrated in FIG. 2, it corresponds to the length of the arrow D2).

Similarly, as illustrated in FIG. 2, the middle hole 411h that is defined by each of the middle annular parts 412 has a length G2 in the tire circumferential direction longer than the length F2 in the tire radial direction, i.e., it has a transverse shape in the side view of the non-pneumatic tire 1.

Here, the length G2 in the tire circumferential direction of the middle hole 412h refers to the largest length in the tire circumferential direction of the middle hole 412h among the length in the tire circumferential direction at each position in the tire radial direction.

In addition, the length F2 in the tire radial direction of the middle hole 412h refers to the largest length in the tire radial direction of the middle hole 411h among the length in the tire radial direction at each position in the tire circumferential direction.

As illustrated in FIG. 2, an inner additional hole 44h is defined by the inner cylinder 2, the pair of inner annular parts 411 adjacent to each other in the tire circumferential direction, and the bridge 42 connecting the pair of inner annular parts 411 to each other. The inner additional hole 44h penetrates the connecting body 4 in the tire width direction.

Also, a middle additional hole 45h is defined by the pair of inner annular parts 411 adjacent to each other in the tire circumferential direction, the bridge 42 connecting the pair of inner annular parts 411 to each other, and the pair of middle annular parts 412 connected to the end portion on the tire outer circumferential side of each of the pair of inner annular parts 411. The middle additional hole 45h penetrates the connecting body 4 in the tire width direction.

In addition, an outer additional hole 46h is defined by the pair of middle annular parts 412 adjacent to each other in the tire circumferential direction, the pair of outer connecting body part 413 connected to the end portion on the tire outer circumferential side of each of the pair of middle annular parts 412, and the outer cylinder 3. The outer additional hole 46h penetrates the connecting body 4 in the tire width direction.

As explained above, in this embodiment, the connecting body 4 has: the plurality of unit-connecting-body portions 41 arranged along the tire circumferential direction, and the plurality of bridges 42 that connect the plurality of unit-connecting-body portions 41 to each other. Each of the unit-connecting-body portions 41 has: the inner annular part 411 having the pair of inner branches 411b that are connected to each other on the inner cylinder 2 and gradually move away from each other in the tire circumferential direction as moving outward in the tire radial direction, then gradually approach each other and are connected to each other, a middle annular part 412 having the pair of middle branches 412b that are connected to each other at the end portion on the tire outer circumferential side of the inner annular part 411 and gradually move away from each other in the tire circumferential direction as moving outward in the tire radial direction, then gradually approach each other and are connected to each other, an outer connecting body part 413 having the pair of outer branches 413b that are connected to each other at the end portion on the tire outer circumferential side of the middle annular part 412 and gradually move away from each other in the tire circumferential direction as moving outward in the tire radial direction, and then are connected to the outer cylinder 3. Each of the bridges 42 connects the tire circumferential end portions 411t of the inner annular parts 411 adjacent to each other in the tire circumferential direction. The tire circumferential end portions 412t of the middle annular parts 412 adjacent to each other in the tire circumferential direction are connected to each other. Each of the inner annular parts 411 has the length D1 in the tire radial direction longer than the length E1 in the tire circumferential direction, and each of the middle annular parts 412 has the length E2 in the tire circumferential direction longer than the length D2 in the tire radial direction. The outer annular part 43 is composed of the outer connecting body part 413, and the outer cylinder connecting part 3a that is a part of the outer cylinder 3, connecting the pair of outer branches 413b of the outer connecting body part 413 to each other.

A vertically elongated inner annular part 411 is less likely to be compressed in the tire radial direction than the horizontally elongated middle annular part 412. In addition, the outer annular part 43 is substantially triangular in shape with its base on the tire outer circumferential side, therefore, it is easy to follow the shape of the ground surface and can easily support loads in the tire radial direction. Therefore, the middle annular part 412 is configured to be more easily compressed in the tire radial direction than the inner annular part 411 and the outer annular part 43. The inner annular part 411, the middle annular part 412, and the outer annular part 43 are connected to each other at their respective apexes, either directly or via other parts (such as the bridge 42), so that deformation beyond a certain degree is prevented.

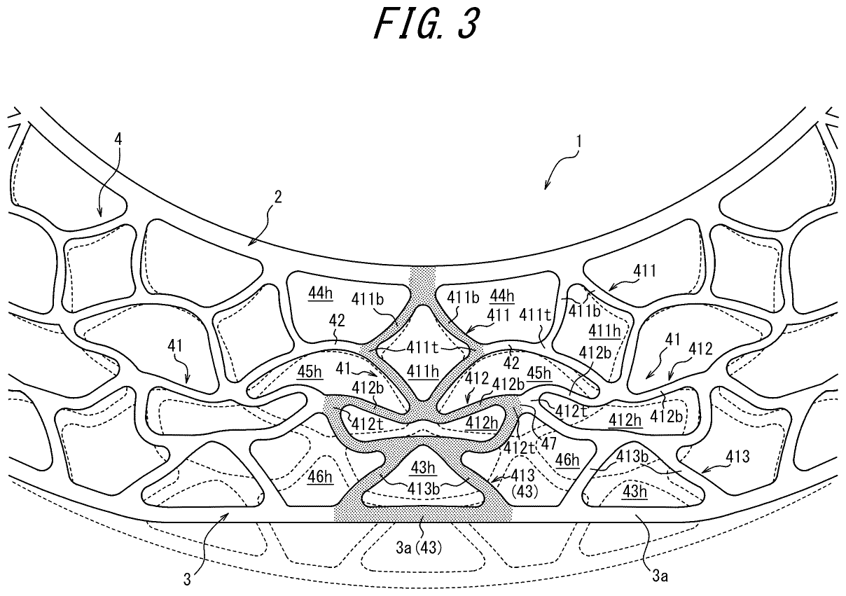

FIG. 3 illustrates the state of the non-pneumatic tire 1 of this embodiment when a load is applied (and thus when the tire comes into contact with the ground). In FIG. 3, the state when a load is applied (and thus when the tire is in contact with the ground) is illustrated by a solid line, and the state when no load is applied (and thus, when the tire is not in contact with the ground) as in FIG. 2 is illustrated by a dashed line. As illustrated by the solid line in FIG. 3, in the non-pneumatic tire 1 of this embodiment, when a load is applied, the connecting body 4 is compressed and deformed on the inner side in the tire radial direction of the ground contact surface, allowing the outer cylinder 3 to deform to follow the shape of the ground contact surface. During this state, the inner annular part 411 and the outer annular part 43 are not significantly compressed and deformed in the tire radial direction, but the middle annular part 412 is crushed in the tire radial direction. In other words, the middle annular part 412 is compressed and deformed in the tire radial direction to a greater extent than each of the inner annular part 411 and the outer annular part 43. As a result, the impact and vibration transmitted from the road surface is effectively absorbed at the middle annular part 412, and is prevented to be transmitted to the vehicle body. This improves the ride comfort performance.

The horizontally elongated middle annular part 412 allows deformation in the tire radial direction, while the vertically elongated inner annular part 411 allows shear deformation in the tire circumferential direction. The vertically elongated inner annular part 411 allows for shear deformation in the tire circumferential direction, so the horizontally elongated middle annular part 412 connected to the inner annular part 411 is more easily deformed. This allows the impact and vibration transmitted from the road surface to be absorbed more effectively at the middle annular part 412.

In addition, because of the bridge section 42, an additional middle hole 45h is partitioned on the tire outer circumferential side thereof, and the additional middle hole 45h acts like a cushion. This prevents a connecting portion 47 between the tire circumferential end portions 412t of the pair of middle annular parts 412, which locates on the tire outer circumferential side of the middle additional hole 45h, from deforming and swelling excessively upward (towards the tire inner circumferential side). This can further improve the ride comfort performance.

In addition, according to this embodiment, as illustrated in FIG. 3, when a load is applied, the connecting body 4 can be compressed and deformed over the plurality of unit-connecting-body portions 41 (and, in turn, the middle annular part 412 can be compressed and deformed in the tire radial direction to a greater extent than each of the inner annular part 411 and the outer annular part 43 in the plurality of unit-connecting-body portions 41). This allows for compressive deformation over a wide area and the stress is dispersed in this way, therefore, it is possible to prevent stress from concentrating in one place. This improves durability.

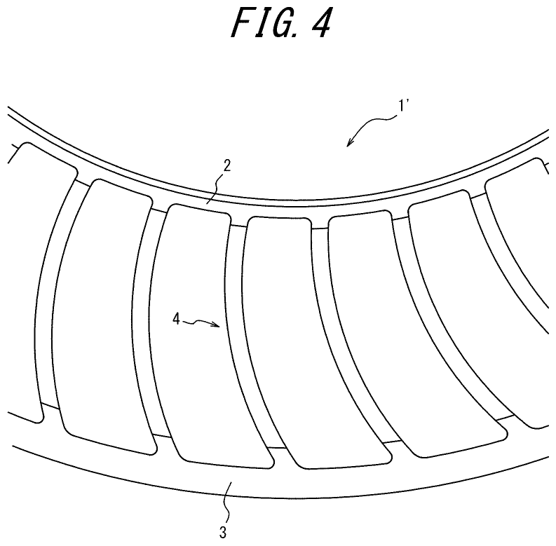

In addition, according to this embodiment, the connecting body 4 forms a reticular shape, thus, the length of each columnar part is shorter than the case, for example, as in the Comparative Example 1 illustrated in FIG. 4, where the connecting body 4 is made up of a plurality of columnar parts connecting the inner cylinder 2 and the outer cylinder 3 to each other, which extend along curved lines and are arranged at intervals from each other in the tire circumferential direction. As a result, the width of each columnar part can be made thinner while maintaining the same rigidity and stress under load, and this in turn makes it possible to reduce the weight.

In the following, when describing the shapes formed by the inner annular part 411, the middle annular part 412, and the outer annular part 43 in a side view of the non-inflated tire 1, each shape refers to the shape formed by the center lines of the thickness of parts (i.e., the inner branch 411b in the case of the inner annular part 411, the middle branch 412b in the case of the middle annular part 412, and the outer branch 413b and the outer cylinder connecting part 3a in the case of the outer annular part 43) of the inner annular part 411, the middle annular part 412, and the outer annular part 43 in a side view of the non-pneumatic tire 1.

As illustrated in FIG. 2, in a side view of the non-pneumatic tire 1, it is preferable that each of the inner annular parts 411 is substantially rhombic in shape. In this case, it is preferable that the longer of the two diagonals of the substantially rhombic shape formed by each of the inner annular parts 411 is parallel to the tire radial direction.

As a result, the inner annular part 411 can more effectively compress the middle annular part 412 in the tire radial direction without compressing itself too much in the tire radial direction when a load is applied, and in turn, the ride comfort performance can be further improved.

However, as long as the length D1 in the tire radial direction of each o the inner annular parts 411 is longer than the length E1 in the tire circumferential direction thereof, as described above, the inner annular part 411 may have any shape in a side view of the non-pneumatic tire 1.

From the same perspective, as illustrated in FIG. 2, in a side view of the non-pneumatic tire 1, it is preferable that the inner hole 411h, which is defined by each of the inner annular parts 411, is substantially in rhombic in shape. In this case, it is preferable that the longer of the two diagonals of the substantially rhombic shape formed by each of the inner holes 411h is parallel to the tire radial direction.

However, as long as the length F1 in the tire radial direction of each of the inner halls 411h is longer than the length G1 in the tire circumferential direction thereof, as described above, the inner hall 411h may have any shape in a side view of the non-pneumatic tire 1.

As illustrated in FIG. 2, in a side view of the non-pneumatic tire 1, it is preferable that each of the middle annular parts 412 is substantially trapezoidal in shape. In this case, it is preferable that the height direction of the trapezoid formed by each of the middle annular parts 412 is parallel to the tire radial direction. In addition, in this case, it is preferable that the longer of the two base sides of the trapezoid formed by each of the middle annular parts 412 is positioned more inward in the tire radial direction than the shorter base side.

As a result, the middle annular part 412 can be more effectively compressed in the tire radial direction by the inner annular part 411 and the outer connecting body part 413 when a load is applied, and this in turn further improves the ride comfort performance.

From the same perspective, in a side view of the non-pneumatic tire 1, it is also preferable that each of the middle annular parts 412 is substantially oval in shape. In this case, it is preferable that the short axis of the substantially oval shape formed by each of the middle annular parts 412 is parallel to the tire radial direction.

From the same perspective, in a side view of the non-pneumatic tire 1, it is preferable that each of the middle annular parts 412 is substantially rhombic in shape.

However, as long as the length E2 in the tire circumferential direction is longer than the length D2 in the tire radial direction, as described above, each of the middle annular parts 412 may have any shape in a side view of the non-pneumatic tire 1.

From the same perspective, as illustrated in FIG. 2, it is preferable that the middle hole 412h, which is defined by each of the middle annular parts 412, is substantially trapezoidal in shape in a side view of the non-pneumatic tire 1. In this case, it is preferable that the height direction of the trapezoid formed by each of the intermediate holes 412h is parallel to the tire radial direction. In addition, in this case, it is preferable that the longer of the two base sides of the trapezoid formed by each of the middle holes 412h is positioned more inward in the tire radial direction than the shorter base side.

In addition, in a side view of the non-pneumatic tire 1, it is also preferable that each middle hole 412h is substantially oval in shape. In this case, it is preferable that the short axis of the substantially oval shape formed by each of the middle holes 412h is parallel to the tire radial direction.

However, as long as the length G2 in the tire circumferential direction is longer than the length F2 in the tire radial direction, as described above, each of the middle holes 412 may have any shape in a side view of the non-pneumatic tire 1.

As illustrated in FIG. 2, it is preferable in each of the unit-connecting-body portions 41 that the length D1 in the tire radial direction of the inner annular part 411 is longer than the length D2 in the tire radial direction of the middle annular part 412. In addition, it is preferable in each of the unit-connecting-body portions 41 that the length E2 in the tire circumferential direction of the middle annular part 412 is longer than the length E1 in the tire circumferential direction of the inner annular part 411.

As a result, the middle annular part 412 can be more effectively compressed in the tire radial direction by the inner annular part 411 and the outer connecting body part 413 when a load is applied, and this in turn further improves the ride comfort performance.

Similarly, as illustrated in FIG. 2, it is preferable in each of the unit-connecting-body portions 41 that the length F1 in the tire radial direction of the inner hole 411h, which is defined by the inner annular part 411, is longer than the length F2 in the tire radial direction of the middle hole 412h, which is defined by the middle annular part 412. In addition, it is preferable in each of the unit-connecting-body portions 41 that the length G2 in the tire circumferential direction of the middle hole 412h, which is defined by the middle annular part 412, is longer than the length G1 in the tire circumferential direction of the inner hole 411h, which is defined by the inner annular part 411.

As illustrated in FIG. 2, in a side view of the non-pneumatic tire 1, it is preferable that each of the outer annular parts 43 is substantially triangular in shape with a base that is roughly parallel to the tire circumferential direction on the tire outer circumferential side. In this case, the base of the substantially triangular shape formed by each of the outer annular parts 43 is composed of the center line of the thickness of the outer cylinder connecting part 3a of the outer cylinder 3. In this case, it is preferable that the height direction of the substantially triangular shape formed by each of the outer annular parts 43 is parallel to the tire radial direction. In addition, in this case, it is preferable that the substantially triangular shape formed by each of the outer annular parts 43 is substantially an isosceles triangle.

As a result, the outer annular part 43 can more effectively compress the middle annular part 412 in the tire radial direction without compressing itself too much in the tire radial direction when a load is applied, and in turn, the ride comfort performance can be further improved.

Similarly, as illustrated in FIG. 2, in a side view of the non-pneumatic tire 1, it is preferable that the outer hole 43h, which is defined by each of the outer annular parts 43, is substantially triangular in shape with a base that is roughly parallel to the tire circumferential direction on the tire outer circumferential side. In this case, it is preferable that the height direction of the substantially triangular shape formed by each of the outer holes 43h is parallel to the tire radial direction. In addition, in this case, it is preferable that the substantially triangular shape formed by each of the outer holes 43h is substantially an isosceles triangle.

As illustrated in FIG. 2, it is preferable that each of the unit-connecting-body portions 41 has the same shape as each other. In addition, it is preferable that each of the unit-connecting-body portions 41 is linearly symmetric with respect to the tire radial direction at the center position in the tire circumferential direction, respectively.

### EXAMPLES

Models of the non-pneumatic tire 1 according to Example 1 and Comparative Example 1 were created and evaluated by analysis, which will be described below.

The model of the non-pneumatic tire 1 in accordance with Example 1 had the configuration illustrated in FIG. 2.

The model of the non-pneumatic tire 1 in accordance with Comparative Example 1 was different from the model in Example 1 only in shape, as illustrated in FIG. 4. To be more specific, in the model in Comparative Example 1, the connecting body 4 was made up of a plurality of columnar parts connecting the inner cylinder 2 and the outer cylinder 3 to each other, which extend along curved lines and are arranged at intervals from each other in the tire circumferential direction.

The models in Example 1 and Comparative Example 1 had the same tire size (PCR 155/70R13) and the same material properties.

The results of the analysis of stress, vertical spring, and weight for Example 1 and Comparative Example 1 are provided in Table 1 below. It should be noted that the values provided in Table 1 all represent indexes when the value of the analysis result of Comparative Example 1 is set to 100. The values for stress, vertical spring, and weight provided in Table 1 all indicate that the higher the value, the higher the stress, vertical spring, and weight. In addition, the stress in Table 1 represents the index value of the maximum stress generated in each model when a load is applied to each model.

TABLE 1

| | Stress | Vertical spring | Weight |
|---|---|---|---|
| | (—) | (—) | (—) |
| Comparative | 100 | 100 | 100 |
| Example 1 | | | |
| Example 1 | 96 | 65 | 86 |

As can be seen from the results provided in Table 1, in comparison with Comparative Example 1, Example 1 had a lower vertical spring while having an equivalent level of stress as Comparative Example 1. This means that Example 1 can be made more flexible than Comparative Example 1 and improve the ride comfort performance while maintaining an equivalent level of stress and durability as Comparative Example 1. In addition, Example 1 was lighter while having an equivalent level of stress as Comparison Example 1. This means that Example 1 can be made lighter than Comparative Example 1 while maintaining an equivalent level of stress and durability as Comparative Example 1.

### INDUSTRIAL APPLICABILITY

The non-pneumatic tire in accordance with this disclosure can be used on any moving object (e.g., small mobilities, light vehicles, passenger vehicles, various other vehicles, motorcycles, wheelchairs, etc.), and is particularly suitable for use on the small mobilities or the light vehicles.

### REFERENCE SIGNS LIST

1 Non-pneumatic tire
2 Inner cylinder
3 Outer cylinder
3a Outer cylinder connecting part
4 Connecting body
41 Unit-connecting-body portion
411 Inner annular part
411b Inner branch
411t Tire circumferential direction end portion
411h Inner hole
412 Middle annular part
412b Middle branch
412t Tire circumferential direction end portion
412h Middle hole
413 Outer connecting body part
413b Outer branch
42 Bridge
43 Outer annular part
43h Outer hole
44h Inner additional hole
45h Middle additional hole
46h Outer additional hole
W Wheel
T Tread member
O Tire center axis
1′ Non-pneumatic tire in accordance with Comparative Example

1. A non-pneumatic tire comprising:
an inner cylinder,
an outer cylinder disposed on a tire outer circumferential side of the inner cylinder, and
a connecting body that connects the inner cylinder and the outer cylinder, wherein
the connecting body has:
a plurality of unit-connecting-body portions arranged along a tire circumferential direction, and
a plurality of bridges that connect the plurality of unit-connecting-body portions to each other,
each of the unit-connecting-body portions has:
an inner annular part having a pair of inner branches that are connected to each other on the inner cylinder and gradually move away from each other in the tire circumferential direction as moving outward in a tire radial direction, then gradually approach each other and are connected to each other,
a middle annular part having a pair of middle branches that are connected to each other at an end portion on the tire outer circumferential side of the inner annular part and gradually move away from each other in the tire circumferential direction as moving outward in the tire radial direction, then gradually approach each other and are connected to each other, and
an outer connecting body part having a pair of outer branches that are connected to each other at an end portion on the tire outer circumferential side of the middle annular part and gradually move away from each other in the tire circumferential direction as moving outward in the tire radial direction, and then are connected to the outer cylinder,
each of the bridges connects tire circumferential end portions of the inner annular parts adjacent to each other in the tire circumferential direction,
tire circumferential end portions of the middle annular parts adjacent to each other in the tire circumferential direction are connected to each other,
each of the inner annular parts has a length in the tire radial direction longer than a length in the tire circumferential direction, and
each of the middle annular parts has a length in the tire circumferential direction longer than a length in the tire radial direction.

2. The non-pneumatic tire as described in claim 1, wherein an outer annular part is composed of the outer connecting body part and an outer cylinder connecting part, the outer cylinder connecting part being a part of the outer cylinder connecting the pair of outer branches of the outer connecting body part to each other, and
when a load is applied to the non-pneumatic tire, the middle annular part undergoes greater compressive deformation in the tire radial direction than each of the inner annular part and the outer annular part.

3. The non-pneumatic tire as described in claim 1, wherein each of the inner annular parts is substantially rhombic in shape.

4. The non-pneumatic tire as described in claim 1, wherein each of the middle annular parts is substantially trapezoidal, oval, or rhombic in shape.

5. The non-pneumatic tire as described in claim 1, wherein an outer annular part is composed of the outer connecting body part and an outer cylinder connecting part, the outer cylinder connecting part being a part of the outer cylinder connecting the pair of outer branches of the outer connecting body part to each other, and
the outer annular part is substantially triangular in shape with its base on the tire outer circumferential side.

6. The non-pneumatic tire as described in claim 1, wherein the connecting body and the outer cylinder are configured to be elastically deformable.

7. The non-pneumatic tire as described in claim 2, wherein the connecting body and the outer cylinder are configured to be elastically deformable.

8. The non-pneumatic tire as described in claim 3, wherein the connecting body and the outer cylinder are configured to be elastically deformable.

9. The non-pneumatic tire as described in claim 4, wherein the connecting body and the outer cylinder are configured to be elastically deformable.

10. The non-pneumatic tire as described in claim 5, wherein the connecting body and the outer cylinder are configured to be elastically deformable.
